(19) United States
(12) Patent Application Publication
(10) Pub. No.: US 2012/0023474 A1
(43) Pub. Date: Jan. 26, 2012

(54) PRINTED CIRCUIT BOARD LAYOUT SYSTEM AND METHOD FOR PRINTED CIRCUIT BOARD LAYOUT

(75) Inventors: YU-LAN GE, Shenzhen City (CN); CHIU-LING KU, Tu-Cheng (TW); CHIEN-TANG LIN, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/874,233

(22) Filed: Sep. 2, 2010

(30) Foreign Application Priority Data
Jul. 22, 2010 (TW) 99124091

(51) Int. Cl. G06F 17/50

(52) U.S. Cl. 716/137

(57) ABSTRACT

A printed circuit board layout system includes an input unit, an executing unit, a layout unit and a labeling unit. The input unit configured to respond to user operation to generate operation instructions. The operation instructions include execution, layout, and label instructions. The executing unit displays the PCB layout diagram file based on a circuit schematic diagram in response to execution instructions. The layout unit designs the first routes of the PCB layout diagram. The labeling unit labels at least one of the first routes.

### BACKGROUND

1. Technical Field

The present disclosure relates to printed circuit board layout systems.

2. Description of Related Art

A printed circuit board (PCB) layout diagram file is created based on a circuit schematic diagram, and includes a number of function modules. A designer may use a previous layout diagram file as a template for a current project. However, some changes may be made to the file to delete some un-needed portions, such as a connecting relationship between two connecting function modules, may require deletion of all routes connecting the two function modules including routes that are needed for the current project. Which means the designer will have to recreate those routes, which is complicated, troublesome and a waste of time.

Therefore, there is room for improvement in the art.

### BRIEF DESCRIPTION OF THE FIGURE

Many aspects of the embodiments can be better understood with reference to the following drawings. The components in the drawings are not necessarily drawn to scale, the emphasis instead being placed upon clearly illustrating the principles of the PCB layout system and method thereof. Moreover, in the drawings, like reference numerals designate corresponding parts throughout the several views.

FIG. 1 is a block diagram of a printed circuit board layout system in accordance with an exemplary embodiment.

FIG. 2 is a schematic diagram of a working window displaying a printed circuit board layout.

FIG. 3 is a flowchart of a method for the printed circuit board layout, in accordance with an exemplary embodiment.

### DETAILED DESCRIPTION

Embodiments of the present disclosure will now be described in detail with reference to the drawings.

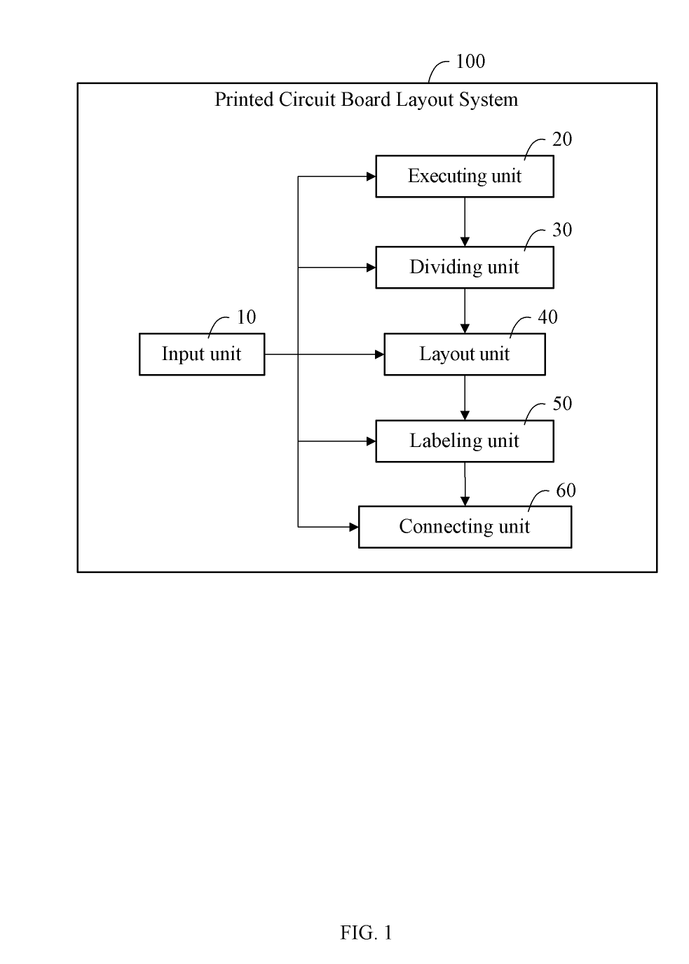

Referring to FIG. 1, a printed circuit board (PCB) layout system 100 includes an input unit 10, an executing unit 20, a dividing unit 30, a layout unit 40, a labeling unit 50, and a connecting unit 60. In the embodiment, a PCB diagram designed using the system 100 based on a circuit schematic diagram is a multilayer board.

The input unit 10 is configured to respond to user operations to generate operation instructions. The operation instructions include but are not limited to execution, division, layout, label, and connection instructions.

The executing unit 20 is configured to display the contents of PCB layout diagram file in response to an execution instruction. The PCB layout diagram file includes information of a number of elements, and connecting relationship of the elements.

The dividing unit 30 is configured to divide the PCB layout diagram into a first function module and a second function module in response to division instructions. The first function module and the second function module can be set on different layers of the PCB. In other embodiments, the dividing unit 30 can divide the PCB layout diagram file into more than two function modules.

The layout unit 40 is configured to design routes for the two function modules in response to layout instructions. In the embodiment, the layout unit 40 is used to design a plurality of first routes for the first function module, and a plurality of second routes for the second function module.

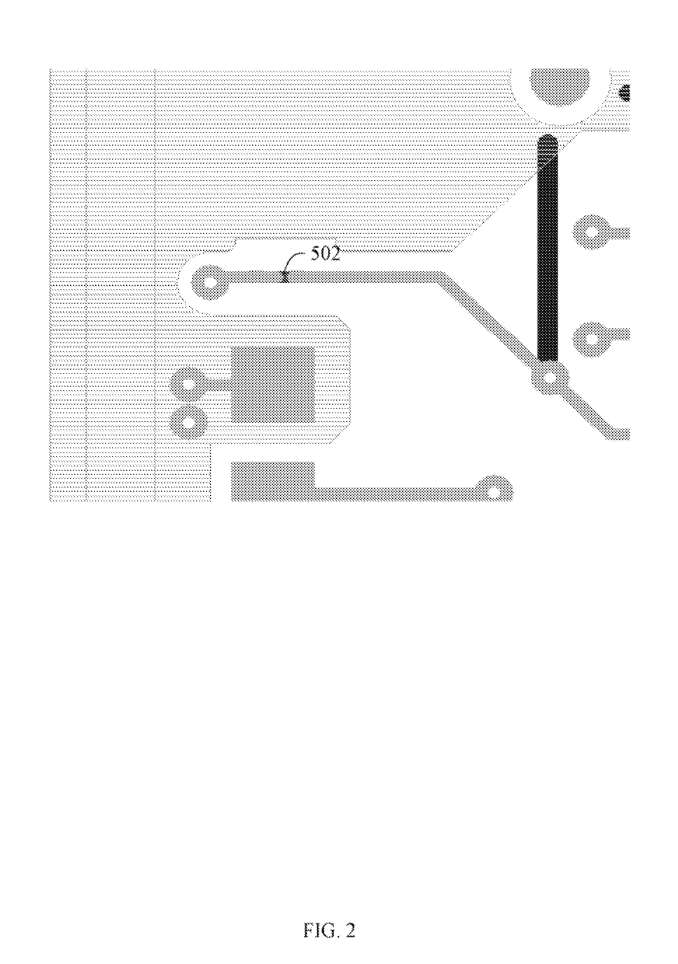

The labeling unit 50 is configured to label the first and the second routes in response to label instructions. The label 502 (FIG. 2) is one example of such a label. Any first and second routes that are to be connected to each other will be labeled with the same name. The label 502 may have some portion color-coded to identify the label 502. The coded portion may, for example, be at a free end of each first route and second route.

The connecting unit 60 is configured to connect the first and second routes with the same label with third routes in response to the connection instructions, thus first function module and the second function module are connected.

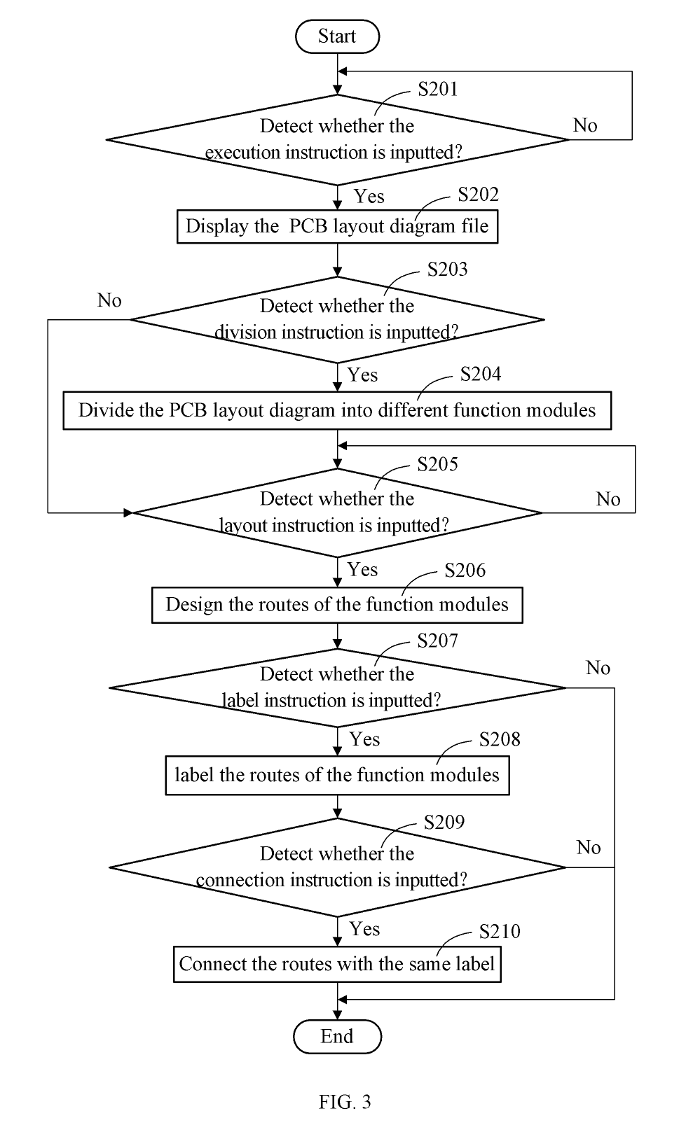

Referring to FIG. 3, a flowchart of a method for PCB layout is illustrated.

In step S201, detecting whether an execution instruction is inputted. The process goes to step S202 when yes, and the process repeats the step S201 if no.

In step S202, the executing unit 20 obtains the execution instruction and displays the PCB layout diagram. The PCB layout diagram file includes the information of a number of elements and connecting relationship of the elements.

In step S203, detecting whether the division instruction is inputted. The process goes to step S204 when yes, and the process goes to step S205 if no.

In step S204, the dividing unit 30 obtains the division instruction and divides the PCB layout diagram into different function modules. The first function module and the second function module can set on different layers of the PCB. In other embodiment, the step S204 can divide the PCB layout diagram file into more than two function modules.

In step S205, detecting whether layout instruction is inputted. The process goes to step S206 when yes, and the process repeats step S205 if no.

In step S206, the layout unit 40 obtains the layout instruction and designs routes for the two function modules. In the embodiment, the layout unit 40 designs a plurality of first routes for the first function module, and a plurality of second routes for the second function module.

In step S207, detecting whether the label instruction is inputted. The process goes to step S208 when yes, and the process is ends if no.

In step S208, the labeling unit 50 obtains the label instruction and labels the first and the second routes. Any first and second routes that are to be connected to each other will be labeled with the same name. The label 502 may have some portion color-coded to identify the label 502. The coded portion may, for example, be at a free end of each first route and second route.

In step S209, detecting whether the connection instruction is inputted. The process goes to step S210 when yes, and the process ends if no.

In step S210, the connecting unit 60 obtains the connection instruction and connects the first and second routes with the same label with third routes, such as the first function module and the second function module are connected.

In use, when a designer uses a previous layout diagram file as a template for a current project, changes to the file to delete some un-needed portions, the designer can simply delete the un-needed routes without deleting connected portions.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A printed circuit board (PCB) layout system, comprising:
an input unit configured to respond to user operations to generate operation instructions, the operation instruction comprising execution, layout, and a label instructions;
an executing unit configured to display the PCB layout diagram file based on a circuit schematic diagram in response to an execution instruction;
a layout unit configured to design first routes and second routes of the PCB layout diagram in response to the layout instruction; the first routes capable of connecting with the second routes; and
a labeling unit configured to label the first and the second routes in response to label instructions.

2. The printed circuit board layout system of claim 1, wherein the labels are the same.

3. The printed circuit board layout system of claim 1, wherein the labels are different.

4. The printed circuit board layout system of claim 1, wherein the labels have some portion color-coded to identify the label.

5. The printed circuit board layout system of claim 4, wherein the coded portion is set at a free end of each first route and second route.

6. The printed circuit board layout system of claim 1, wherein the printed circuit board layout system further comprises a connecting unit, the operation instructions further includes connection instructions, the connecting unit configured to connect the first and second routes with the same label with third routes in response to the connection instructions.

7. The printed circuit board layout system of claim 1, wherein the printed circuit board layout system further comprises a dividing unit, the operation instructions further includes division instructions, the dividing unit configured to divide the PCB layout diagram file into a first function module and a second function module in response to the division instruction.

8. The printed circuit board layout system of claim 7, wherein the PCB diagram is a multilayer board, the first function module and the second function module can set on the different layers of the PCB board.

9. The printed circuit board layout system of claim 7, wherein the layout unit design first routes in the first function module and second routes in the second function module.

10. A method for the printed circuit board layout, the method being applying for a printed circuit board (PCB) layout system, wherein the printed circuit board layout system comprises an input unit that configured to respond to user operation to generate operation instructions, the operation instructions include execution, division, layout, label and connection instructions, an executing unit that configured to display the PCB layout diagram file, a layout unit that configured to design some first routes of the PCB layout diagram, and a labeling unit that configured to label the first routes;
the method comprising:
detecting whether the execution instruction is generated;
if the execution instruction is generated, displaying the PCB layout diagram file;
detecting whether the layout instruction is generated;
if the layout instruction is generated, designing first routes and second routes in the PCB layout diagram file;
detecting whether the label instruction is generated; and
if the label instruction is generated, labeling the first routes and the second routes.

11. The method of the printed circuit board layout claim 10, wherein the labels have some portion color-coded to identify the label.

12. The method of the printed circuit board layout claim 10, wherein the second routes are external routes connected to the first routes.

13. The method of the printed circuit board layout claim 10, after the step of labeling the first routes and the second routes the step further comprising:
detecting whether the connection instruction is generated; and
if the connection instruction is generated, connecting the first and second routes with a third routes.

14. The method of the printed circuit board layout claim 10, before the step of detecting whether the label instruction is generated the step further comprising:
detecting whether the division instruction is generated; and
if the division instruction is generated, dividing the printed circuit board layout diagram into a first function module and a second function module.

15. The method of the printed circuit board layout claim 11, wherein the printed circuit board is a multilayer board, the first function module and the second function module can set on different layers of the printed circuit board.

16. A printed circuit board (PCB) layout system, comprising:
an input unit configured to respond to user operations to generate operation instructions, the operation instruction comprising execution, layout, and label instructions;
an executing unit configured to display the PCB layout diagram file based on a circuit schematic diagram in response to the execution instruction;
a layout unit configured to design first routes of the PCB layout diagram in response to the layout instruction; and
a labeling unit configured to label at least one of the first routes.

17. The printed circuit board layout system of claim 16, wherein the labels have some portion color-coded to identify the label.
